(19) United States
(12) Patent Application Publication
(10) Pub. No.: US 2023/0001888 A1
(43) Pub. Date: Jan. 5, 2023

(54) PROJECTING INFRARED EMISSIONS FOR SURFACE HEATING

(71) Applicant: Motional AD LLC, Boston, MA (US)

(72) Inventors: Nijumudheen Muhassin, Jefferson Hills, PA (US); Low Yew Kwang, Singapore (SG); Jayesh Dwivedi, Pittsburgh, PA (US)

(21) Appl. No.: 17/852,496

(22) Filed: Jun. 29, 2022

Related U.S. Application Data
(60) Provisional application No. 63/216,986, filed on Jun. 30, 2021.

(51) Int. Cl. B60S 1/02; B60S 1/56

(52) U.S. Cl. CPC B60S 1/023; B60S 1/56

(57) ABSTRACT

Provided is a vehicle including one or more of an IR emitter, ring lens, ring wedge, or any combinations thereof. In an embodiment, an infrared emitter configured to output energy. A ring lens receive the energy output by the infrared emitter and converges the energy to a predetermined field coverage. The predetermined field coverage is determined based on, at least in part, the surface to be heated. The surface to be heated receives the converged energy and is heated.

### CROSS REFERENCE TO RELATED APPLICATIONS

This application claims priority to U.S. Provisional Patent Application No. 63/216,986, filed Jun. 30, 2021, the entire contents of which are incorporated herein by reference.

### BACKGROUND

Vehicle surfaces can experience fluids that are frozen onto the surface in cold temperatures. Frozen fluids on vehicle surfaces can negatively impact components that include a respective surface with frozen fluid.

### BRIEF DESCRIPTION OF THE FIGURES

FIG. 1 is an example environment in which a vehicle including one or more components of an autonomous system can be implemented.

FIG. 2 is a diagram of one or more systems of a vehicle including an autonomous system.

FIG. 3 is a diagram of components of one or more devices and/or one or more systems of FIGS. 1 and 2.

FIG. 4 is a diagram of certain components of an autonomous system.

FIG. 5 is a diagram of an implementation of a process for control of an assembly including one or more of an IR emitter, ring lens, ring wedge, or any combinations thereof.

FIG. 6 is an illustration of an internal infrared (IR) emitter.

FIG. 7 is an illustration of an IR emitter heating a lens surface and lens barrel.

FIG. 8 is an illustration of IR assemblies heating a surface.

FIG. 9 is a process flow diagram that enables projecting infrared emissions for surface heating.

FIG. 10 is a process flow diagram of a process for IR emitter activation.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include projected infrared (IR) emitters of radiation heating ring light on a lens and optical window surface. For example, an IR emitter transfers heat through electromagnetic radiation. A lens is used to converge the electromagnetic radiation output by the IR emitter. In an embodiment, the lens used to converge the electromagnetic radiation output by the IR emitter is a ring lens. In an embodiment, a ring wedge receives the converged electromagnetic radiation and redirects the electromagnetic radiation such that heating is achieved with the assembly (e.g., IR emitter, ring lens, ring wedge, or any combinations thereof) positioned outside the field of view (FOV) of the surface to be heated.

In some aspects and/or embodiments, systems, methods, and computer program products described herein include control and operation of IR emitters that project electromagnetic radiation to heat a surface. A ring lens converges the electromagnetic radiation and projects the electromagnetic radiation onto a predetermined field coverage. In embodiments, a ring wedge receives the converged electromagnetic radiation and redirects the electromagnetic radiation. By redirecting the electromagnetic radiation, an assembly that includes at least one IR emitter, at least one ring light assembly, at least one ring lens, or any combinations thereof, are operable to heat a surface while being positioned outside a FOV of the surface to be heated.

By virtue of the implementation of systems, methods, and computer program products described herein, the present techniques project 1.5 um wavelength and above IR radiation, which will not interfere with vision and NIR LiDAR systems as the wavelength is beyond what the lens and window coating could transmit. The present techniques enable non-contact heating all around a lens, a protective window, adjacent lens barrel surface, or any combinations thereof. Moreover, the present techniques have a lower cost and are more robust that conventional heaters. In some implementations, the present techniques enable mitigating frozen nozzles by applying heat as described herein.

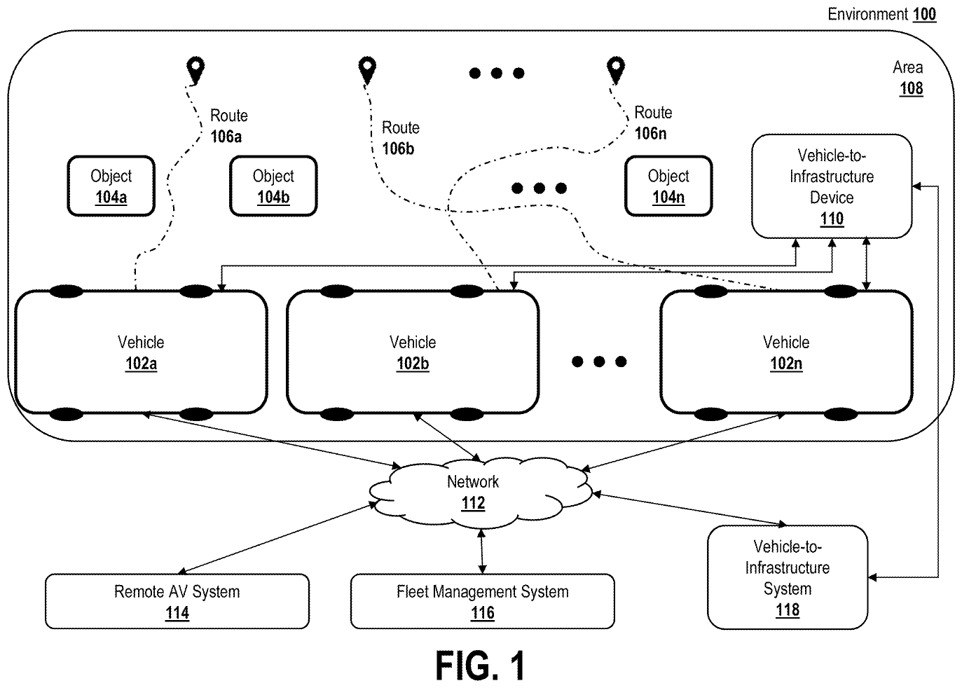

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

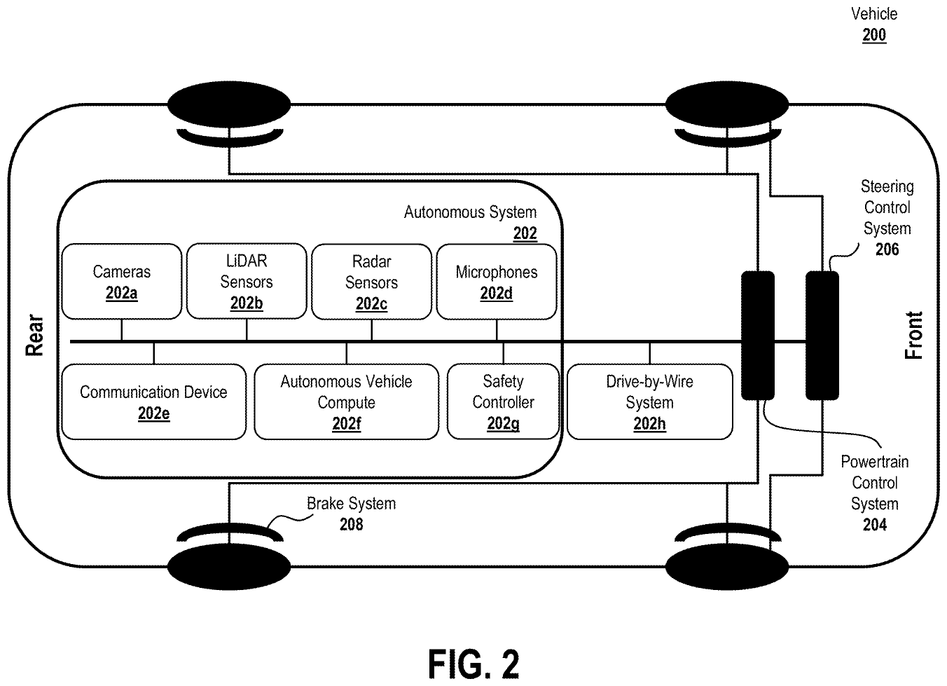

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 have autonomous capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like). In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

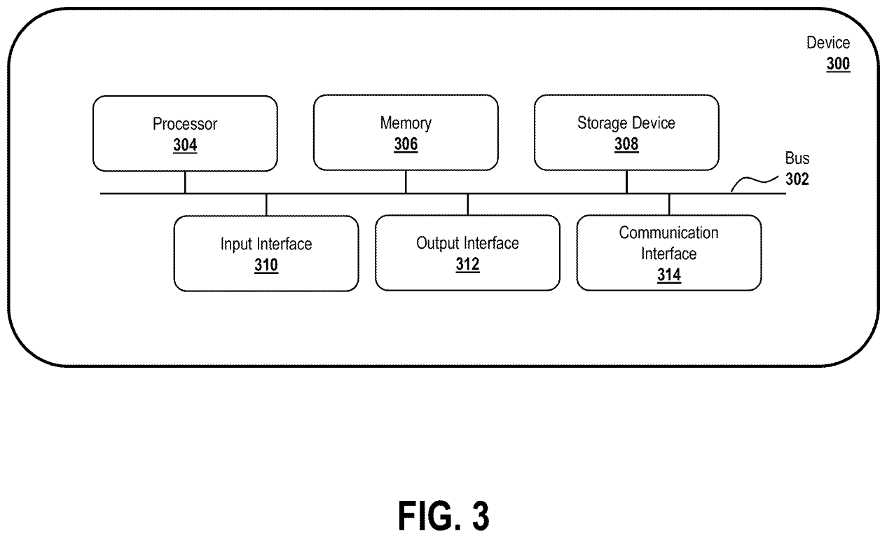

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction, or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device described herein such as a controller for an assembly including one or more of an IR emitter, ring lens, ring wedge, or any combinations thereof, and/or one or more devices of network 112 (e.g., one or more devices of a system of network 112). In some embodiments, one or more devices of vehicles 102 (e.g., one or more devices of a system of vehicles 102), at least one device described herein such as a controller for an assembly including one or more of an IR emitter, ring lens, ring wedge, or any combinations thereof, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

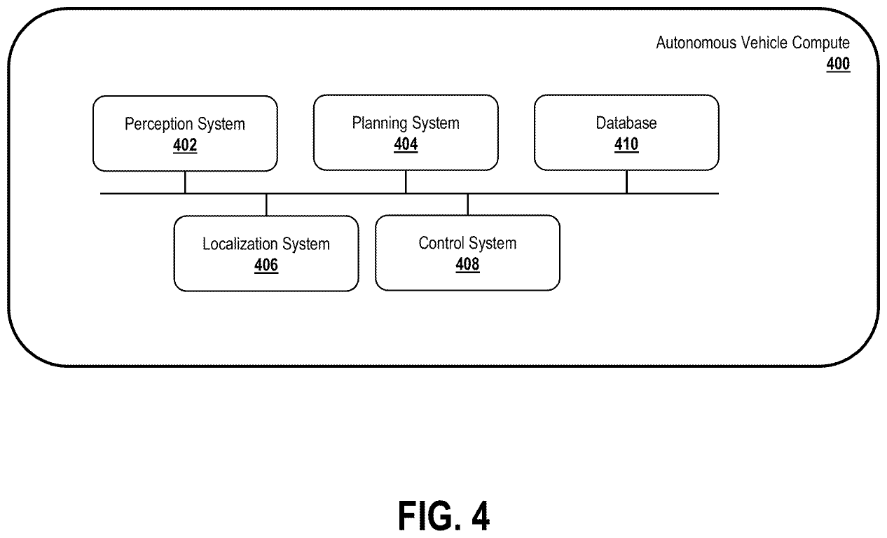

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

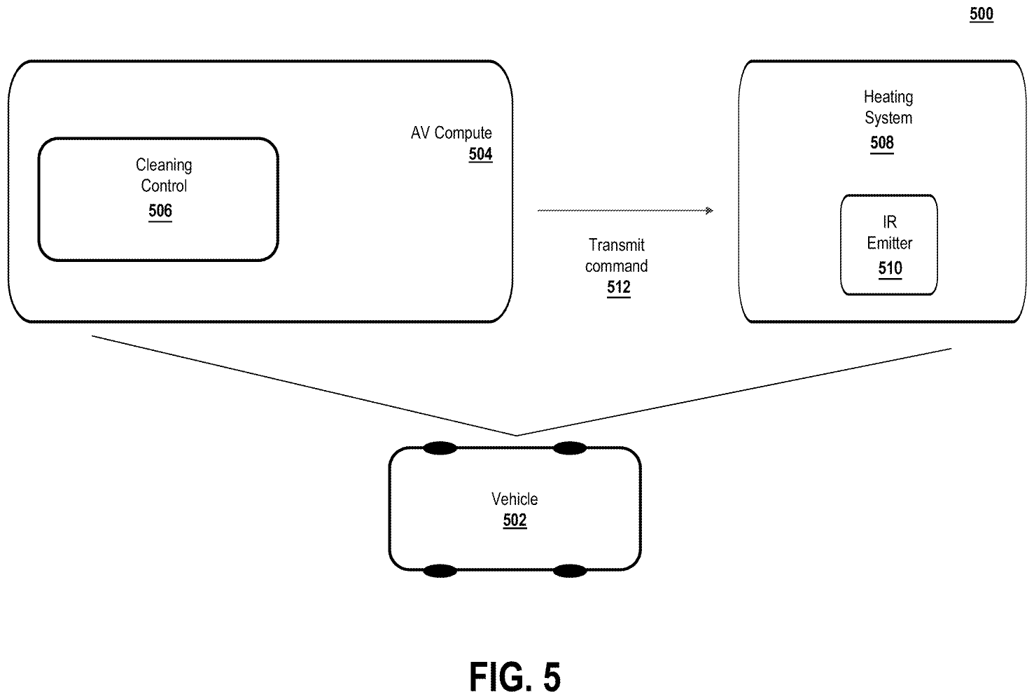

Referring now to FIG. 5, illustrated is a diagram of an implementation 500 of a heating system 508. In some embodiments, vehicle 502 is the same as or similar to the vehicle 102 of FIG. 1 or the vehicle 200 of FIG. 2. In some embodiments, the AV compute 504 is the same as or similar to the AV compute 400 of FIG. 4. In some embodiments, the implementation 500 is realized among any of the above-noted systems in cooperation with one another.

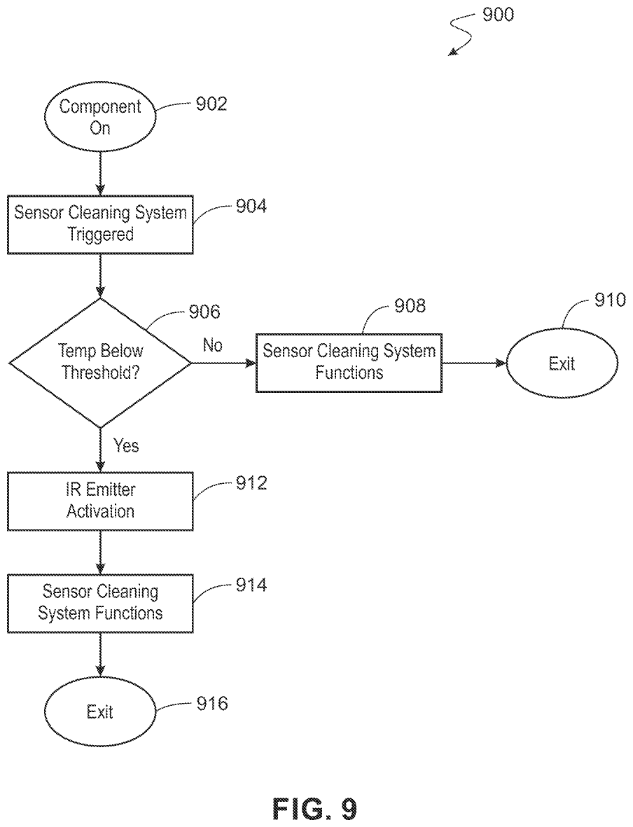

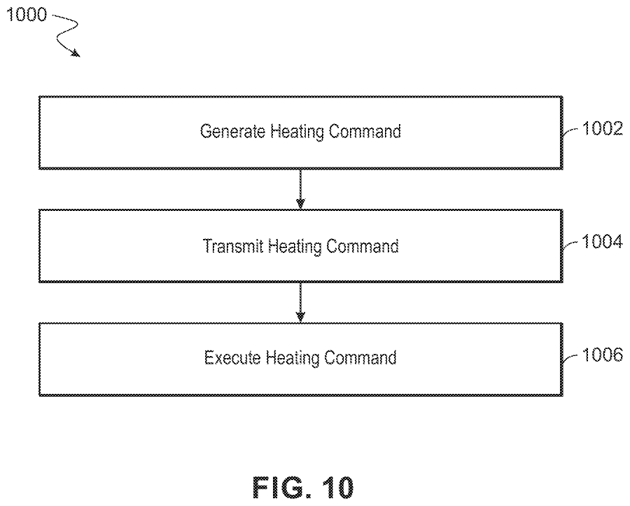

In the example of FIG. 5, AV compute 504 includes a cleaning control 506. The cleaning control 506 executes the process 900 of FIG. 9, the process 1000 of FIG. 10, or any combinations thereof. In some embodiments, at least one temperature at the component is obtained. In examples, the temperature is a temperature of the environment (e.g., environment 100 of FIG. 1) in which a vehicle 502 (e.g., vehicle 102 of FIG. 1) operates. For example, the temperature is a temperature of the environment immediately adjacent to an optical lens, assembly of lenses, cover, protective window or other optical window surface. The optical window surface is associated with one or more sensors, such as a camera, LiDAR, or radar. In an example, the temperature is the ambient temperature of the environment (e.g., the overall temperature of the outdoor air surrounding the vehicle). In some embodiments, the temperature is captured by a temperature sensor of a sensor suite of an autonomous system, such as autonomous system 202f of FIG. 2. In some embodiments, the temperature is derived from sensor data captured by a sensor suite of the autonomous system, such as autonomous system 202f of FIG. 2. For example, an AV compute 504 (e.g., AV compute 202f of FIG. 2) is configured to be in communication with one or more sensors of an autonomous system, and calculates a temperature using the sensor data.

The cleaning control 506 compares an obtained temperature with a predetermined threshold temperature or a predetermined range of temperatures. In some embodiments, if the temperature is below the predetermined threshold or falls outside of the predetermined range, a heating command is generated. In some examples, the predetermined threshold or predetermined range is defined by, at least in part, cold temperatures, temperatures below freezing, temperatures outside of original equipment manufacturer (OEM) specifications, temperatures known to deteriorate device functionality, or any combinations thereof. For example, the predetermined threshold corresponds to temperature below which frozen fluid occurs on an optical window surface of a vehicle. In another example, the predetermined range corresponds to a range of temperatures outside of OEM specifications of a respective sensor.

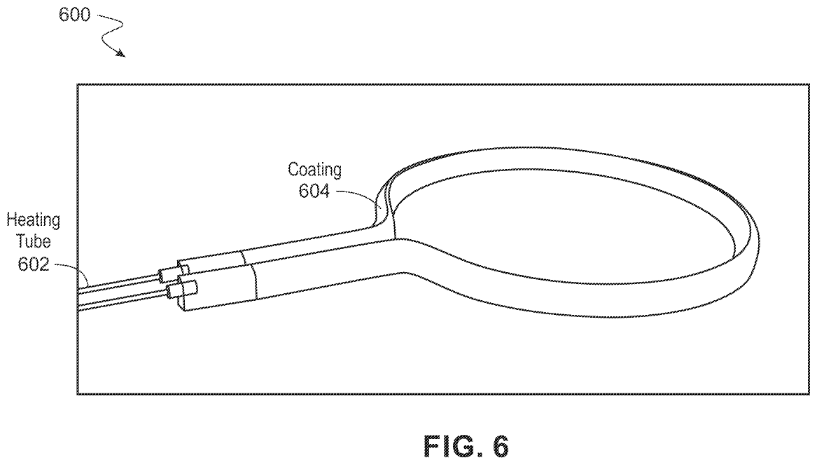

The heating command 512 is transmitted to a heating system 508. In examples, the heating system 508 causes the generation of radiation. For example, the heating system 508 includes an infrared (IR) assembly 510. The IR assembly 510 includes at least one IR emitter, at least one ring light lens, at least one ring wedge, or any combinations thereof. The IR emitter powers on and generates radiation in response to the heating command. In some embodiments, the heating command 512 includes an instruction to power on the IR emitter for a predetermined length of time, a radiation intensity, and the like. In some examples, the IR emitter (e.g., IR emitter 600 of FIG. 6) of the IR assembly 510 emits near-infrared light. When the IR emitter is powered on, electromagnetic radiation causes contactless transfer of heat. In an example, the heat is transferred to a surface (e.g., optical window surface) that is a part of or associated with a component (e.g., a device, sensor, nozzle, or system as described above with respect to FIGS. 1-4) of the vehicle 502. By heating the surface, performance deterioration of the respective component in cold temperatures is reduced or eliminated.

FIG. 6 is an illustration of an infrared (IR) emitter 600. For ease of description, the output of the IR emitter is referred to as energy or electromagnetic radiation. However, the output may also be referred to as a light beam, heat, or a general emission. In an embodiment, the IR emitter emits visible light. In an embodiment, the IR emitter does not emit visible light. The present techniques enable an internal IR emitter that produces electromagnetic radiation that heats another surface. In examples, an internal IR emitter produces radiation that travels across a relatively short distance. An external IR emitter produces radiation that travels across a greater distance when compared with internal IR emitters.

In an example, the IR emitter 600 is an IR light emitting diode (LED) ring light. The IR emitter 600 produces energy that is transferred to at least one surface. In some embodiments, the surface is an optical window surface associated with one or more components of a vehicle (e.g., vehicle 200 of FIG. 2). The IR emitter 600 causes hearing of the surface without physical contact between the IR emitter and the surface. Additionally, the energy produced by the IR emitter 600 is transferred to the surface associated with the component without a medium to transfer the energy. For example, the IR emitter is operable to transfer energy in a vacuum or within an atmosphere without physical contact between the IR emitter and the surface that receives the energy.

In an embodiment, the IR emitter includes an infrared (IR) heating tube 602. For example, the IR heating tube 602 is a quartz glass heating tube. In an embodiment, the IR heating tube 602 includes an IR transmitter. In embodiments, the IR transmitter is configured for carbon fiber, short wave, fast medium wave, standard medium wave, halogen short wave/near infrared emissions. A carbon fiber emitter configured for medium-wave infrared emissions yields a fast response speed. Moreover, the carbon fiber emitter configured for medium-wave infrared emissions enables a stable heater with a good product life cycle.

In some embodiments, the IR heating tube 602 is largely circular in shape. In embodiments, the shape of the IR heating tube corresponds to a shape of the surface to be heated or the shape of a portion of the surface to be heated. In examples, a generally circular lens (e.g., optical window surface) is heated by a generally circular IR heating tube. The shape of the IR heating tube 602 may be circular, oval, elliptical, rectangular, a generally polygonal shape, a generally circular shape, or any combinations thereof.

In the example of FIG. 6, a coating 604 on the heating tube 602 reflects the infrared radiation and directs it towards the surface. For example, a temperature at or near the surface fails to satisfy a predetermined threshold or a predetermined range. A heating command is generated, and the IR emitter causes heating of the surface of the component to increase a temperature at or near the surface. In this example, the IR emitter is not in direct physical contact with the surface or component being heated. In some embodiments, the IR heating tube 602 is precisely matched with the surface. For example, the heating tube 602 shape is selected to correspond to a shape of the surface to be heated. The heating tube 602 is shaped to cause local area heating of an optical window surface. Precise heating that is directed toward a surface, locally, is enabled without directing heat to areas outside of the surface. For example, the faces, edges, angles, and curves of a surface/component receive energy, and all portions of the surface receive an accurate and precise amount of radiation to ensure even heating. The IR emitter 600 emits a large amount of energy in a short time period. For example, a fast response is 1 nanosecond from power on to emitting radiation corresponding to a predetermined heating temperature. A fast response is also 1 nanosecond from power off to the cessation of energy emission. Local area heating as described herein reduces power consumption when heating optical window surfaces and the corresponding components.

In an example, the heating tube 602 is shaped to heat a generally circular lens (e.g., optical window surface). Frozen fluid on lens surface during a cold season where temperatures reach below a freezing point can negatively affect cameras and LiDAR in AV systems. The freezing point may be, for example, the freezing point of anti-freeze solutions or fluid applied in an AV system. The freezing point may be, for example, the freezing point of water (0° C.). Cold temperatures (including low temperatures above the freezing point) can render a fluid based cleaning system useless, even with increased alcohol concentration in the fluid. Generally, an integrated lens heating system within the lens is costly and inefficient.

In addition to selecting the heating tube 602 shape based on the optical window surface or component to be heated, the heating tube 602 is selected to generate an accurate and precise amount of radiation corresponding to a predetermined heating temperature or predetermined heating temperature range generated by the IR emitter 600. The IR emitter has a fast response time that enables precise control of the output of energy. In examples, the surface to be heated is heated in a localized area, or the entire surface is heated. The length of heating time is precisely controlled as a result of the fast response time. The intensity of the heating is also precisely controlled. This ultimately results in less power consumption with fast heating when compared to other forms of heating.

In examples, the predetermined heating temperature is a temperature (or range) that corresponds to the electromagnetic radiation output by the IR emitter 600. In an embodiment, the wavelength output by the IR emitter 600 is selected such that a majority of the radiation is absorbed by the surface to be heated. For example, short-wave radiation generally includes wavelengths in the range of 780 nanometers to 1.4 micrometers and can penetrate some solid materials to obtain uniform heating throughout the surface to be heated. Medium-wave radiation generally includes wavelengths between 1.4 and three micrometers and is largely absorbed by the surface of the component to be heated, wherein the surface is an outer layer, top layer, or layer of the surface closest to the IR emitter.

In examples, in temperatures below −15° C. frozen fluid accumulates on a surface of the component (e.g., sensors, nozzles). In some embodiments, the accumulation of frozen fluid triggers a cleaning system used for sensor cleaning, and the frozen fluid results in sensor performance degradation. The present techniques reduce frozen fluid on a surface by incorporating a light projecting ring lens on an internal IR emitting ring radiant heater to heat up surfaces of a component, such as a lens barrel, lens surface, protective window, or any combinations thereof. In an embodiment, the present techniques incorporate a light projecting ring lens on an internal IR emitting ring radiant heater to heat surfaces (such as physical AV components described with respect to FIGS. 1-6) as described above. An optical ring lens, ring wedges, and any combinations thereof are used to converge and position the generated radiation (e.g., energy output by the IR emitter) on lenses, protective windows, lens barrel, and other surfaces to enable effective contactless heating to melt frozen fluid in cold freezing environment for an AV.

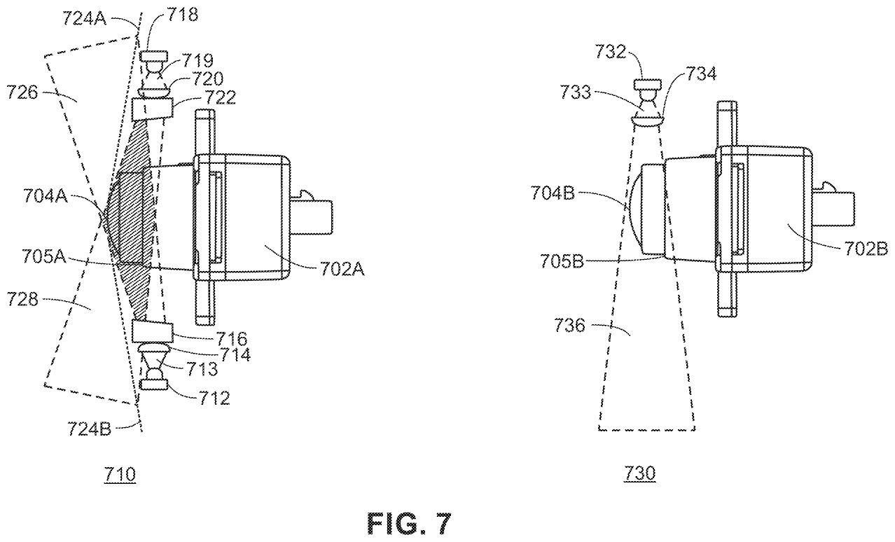

FIG. 7 is an illustration of components 710 and 730 with respective IR assemblies. In some embodiments, the components 710 and 730 are included in a vehicle that is the same as or similar to the vehicle 102 of FIG. 1 or the vehicle 200 of FIG. 2. In some embodiments, the components 710 and 730 are cameras (e.g., cameras 202a of FIG. 2).

In the example of FIG. 7, the component 710 is a fisheye camera 702A including a lens (e.g., optical window surface) 704A. A field of view of the camera 702A is illustrated by dashed lines 724A and 724B. IR emitters 712 and 718 are positioned outside of (e.g., beyond) the field of view of camera 702A illustrated by dashed lines 724A and 724B. In examples, the IR emitters 712 and 718 are internal IR emitters that produce radiation that travels a relatively short distance. In examples, the IR emitters 712 and 718 are divergent, such that a width of radiation emitted from the emitters 712 and 718 increases in diameter as a distance from a respective IR emitter increases. In the example of FIG. 7, radiation 713 output by the IR emitter 712 is divergent, and radiation 719 output by the IR emitter 718 is divergent.

As illustrated, the radiation 713 is received by a ring lens 714. Similarly, the radiation 719 is received by a ring lens 720. In examples, the ring lenses 714 and 720 cause parallel rays of radiation to converge when passing through each respective lens, such that the parallel rays of radiation meet at a point on the opposite side of the respective lens. By deploying ring lens with converging power to concentrate the radiation to a predetermined field coverage, an increased heating power density is generated using radiation from the IR emitters. The field coverage covers, for example, surfaces of the camera 702A including the lens 704A and a portion or all the lens barrel 705A. In some embodiments, ring wedges 716 and 722 received converged radiation from the ring lenses 714 and 720, respectively. Ring wedges 716 and 722 tilt or redirect the beams of radiation 726 and 728 to direct the radiation to a predetermined area (e.g., optical window surface). By tilting or redirecting the radiation 726 and 728 generated for heating, the IR emitters 712 and 718, ring lenses 714 and 720, and ring wedges 716 and 722 (or any combinations thereof) are positioned beyond a field of view (FOV) of the component.

In the example of FIG. 7, the component 710 to be heated includes all or a portion of the fisheye camera 702A, with FOV as illustrated by dashed lines 724A and 724B of greater than 180 degrees. The present techniques enable heating of the entire the lens 704A and adjacent lens barrel 705A by the IR emitters without placement of the heating system in the fisheye camera FOV. Accordingly, the IR emitters, ring lenses, and ring wedges do not intrude upon the FOV of the camera. Moreover, the IR emitters, ring lenses, and ring wedges are not integrated into the surface to be heated.

The component 730 is a fisheye camera 702B including a lens (e.g., optical window surface) 704B and a lens barrel 705B. Similar to component 710, an IR emitter 732 is divergent, such that a width of radiation 733 emitted from the emitter 732 increases in diameter as a distance from the respective IR emitter 732 increases. In the example of FIG. 7, radiation 733 is transmitted to a ring lens 734. The ring lens 734 converges the received radiation 733 into convergent radiation 736. By deploying ring lens 734 with converging power to concentrate the radiation 733 to the convergent radiation 736, an increased heating power density is generated using radiation from the IR emitters.

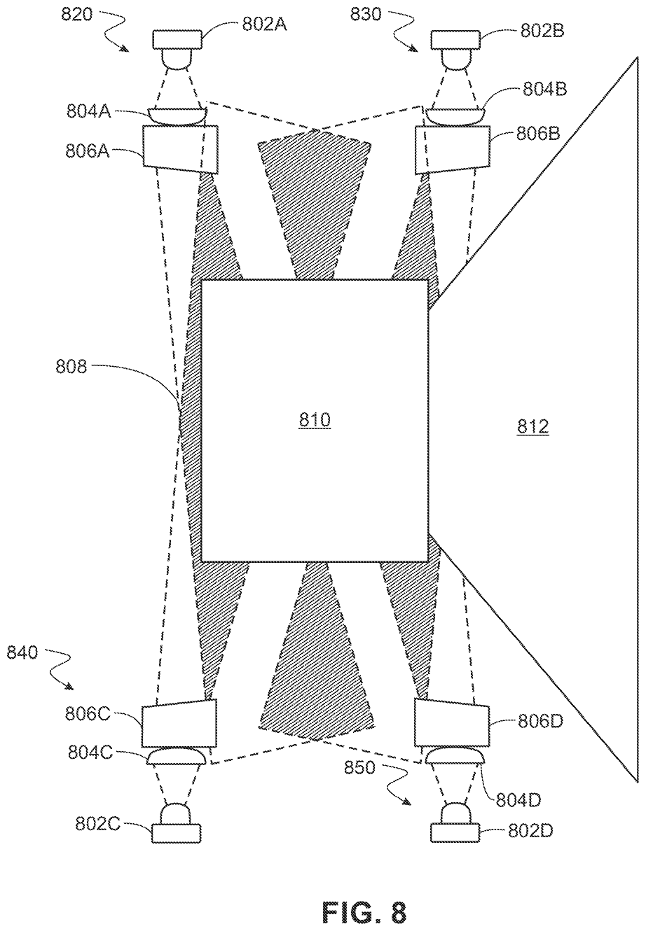

FIG. 8 is an illustration of IR assemblies heating a surface of a component. In examples, the component is a LiDAR 810 (e.g., LiDAR 202b of FIG. 2). In examples, the LiDAR is positioned in a housing that includes a lens or other optical window surface. In some embodiments, the LiDAR is included in a vehicle that is the same as or similar to the vehicle 102 of FIG. 1 or the vehicle 200 of FIG. 2. In the example of FIG. 8, the LiDAR 810 has a corresponding field of view (FOV) 812. In some examples, the FOV is 905 NM. In the example of FIG. 8, IR assemblies 820, 830, 840, and 850 are illustrated. In particular, IR emitters 802A, 802B, 802C, and 802D are illustrated. The IR emitters 802A, 802B, 802C, and 802D emit radiation to ring lenses 804A, 804B, 804C, and 804D. Ring wedges 806A, 806B, 806C, and 806D are used to direct the converged radiation 808 (e.g. field coverage) to surfaces of the LiDAR 810. As illustrated, IR assembly 820 includes IR emitter 802A, ring lens 804A, and ring wedge 806A; IR assembly 830 includes IR emitter 802B, ring lens 804B, and ring wedge 806B; IR assembly 840 includes IR emitter 802C, ring lens 804C, and ring wedge 806C; and IR assembly 850 includes IR emitter 802D, ring lens 804D, and ring wedge 806D.

In the example of FIG. 8, the surfaces being heated correspond to the LiDAR 810. For example, IR assemblies 820 and 830 are positioned on a same side of the LiDAR 810, and the IR assemblies 840 and 850 are positioned on a same side of the LiDAR 810. In some embodiments, the IR assemblies produce radiation with a wavelength of 1500 nm. In some embodiments, the wavelengths of radiation produced by the IS assemblies 820, 830, 840, and 850 is longer than visible light. The IR assemblies transmit energy to the LiDAR 810 for uniform heating. As illustrated, the LiDAR surface is heated by the plurality of IR emitters, each with a corresponding ring lens that converges power to concentrate the radiation to a predetermined field coverage that includes surfaces of the LiDAR. The respective ring wedges tilt the radiation such that the IR assembly is outside the field of view (FOV) of the LiDAR.

In some embodiments, field coverage describes an extent of an area where radiation is output by the IR assembly. Put another way, field coverage refers to the area to be heated. In some embodiments, the field coverage refers to converged radiation output by a respective IR assembly. In examples, the field coverage is a substantially circular area that corresponds to the surface area of a camera lens. In some examples, the field coverage corresponds to a portion of the surface to be heated.

As illustrated in the example of FIG. 8, multiple IR assemblies transmit energy to the surface to be heated in concert, simultaneously outputting energy to heat the surface. In this example, the energy output by each IR emitter is configured independently according to known characteristics of the surface to be heated. Known characteristics of the surface include a temperature gradient or temperature differentials across the surface. Consider a scenario where a first portion of the surface to be heated is known to be cooler than a second portion of the surface when cold temperatures are observed. In examples, such a temperature differential is the result of other heat sources (e.g., other AV hardware) being closer to the second portion of the surface than they are to the first portion of the surface. The temperature differential may also be due to cooling situations being closer to the first portion of the surface when compared to the cooling situations proximity to the second portion of the surface. A cooling situation is, for example, when cold or freezing air is directed at or near the first portion of a lens while largely avoiding the second portion of the lens. In this scenario, an IR emitter of an assembly corresponding to the first portion of the surface outputs energy at a higher intensity when compared to the intensity of energy output by an IR emitter of an assembly corresponding to the second, warmer portion of the surface.

FIG. 9 is a process flow diagram of a process 900 that enables projecting infrared emissions for surface heating. In some embodiments, process 900 is implemented (e.g., completely, partially, etc.) using an autonomous system 202 that is the same as or similar to autonomous system 202, described in reference to FIG. 2. In some embodiments, one or more of the steps of process 900 are performed (e.g., completely, partially, and/or the like) by another device or system, or another group of devices and/or systems that are separate from, or include, the autonomous system. For example, one or more steps of process 900 can be performed (e.g., completely, partially, and/or the like) by remote AV system 114, vehicle 102, and/or AV compute 400 (e.g., one or more systems of AV compute 400). In some embodiments, the steps of process 900 may be performed between any of the above-noted systems in cooperation with one another.

At block 902, the component (e.g., a device, sensor, or system as described above with respect to FIGS. 1-4) of the vehicle is powered on. At block 904, the cleaning system (e.g., cleaning control 506 of FIG. 5) is triggered. In some embodiments, a cleaning system is triggered when debris is detected on the surface of the component. Additionally, in some embodiments a sensor detects a level of contamination on the surface of the component. In some embodiments, data captured by the component is evaluated to determine a level of contamination on the surface. In this manner, the component self-detects contamination and a cleaning system is triggered. Prior to executing cleaning system functions, the present techniques determine if frozen fluid, frozen contaminants, or frozen debris is present on the surface.

At block 906, it is determined if the temperature at the component is below a predetermined threshold temperature. In some embodiments, it is determined if the temperature at the component is outside of a predetermined range of temperatures. For example, a predetermined threshold temperature is a temperature of −5° C. If the temperature is not below the predetermined threshold (or is within the predetermined range), process flow continues to block 908. When the temperature is not below the predetermined threshold and/or within the predetermined range, frozen fluid is unlikely to be present. When frozen fluid is not present, cleaning functions can proceed. Accordingly, at block 908, sensor cleaning system functions are performed. In some embodiments, sensor cleaning includes clearing debris and contaminants from a surface of a component. At block 910, the process ends.

At block 906, if the temperature is below the predetermined threshold (or is not within the predetermined range), process flow continues to block 912. At block 912, the IR emitter is activated. In examples, the IR emitter is powered on for a predetermined time duration. Control of the IR emitter is further described by process 1000 of FIG. 10. When the temperature is below the predetermined threshold and/or outside of the predetermined range, frozen fluid is likely to be present. When frozen fluid is present, cleaning functions cannot proceed until heating has reduced or eliminated the frozen fluid, debris, or contaminants at the optical window surface. Activation of the IR emitter melts the frozen fluid, debris, or contaminants. At block 914, the sensor cleaning system functions are performed. At block 916, the process ends.

Referring now to FIG. 10, illustrated is a process flow diagram of a process 1000 for IR emitter activation. In examples, the process 1000 is performed at block 912 of the process 900 as described with respect to FIG. 9. In some embodiments, process 1000 is implemented (e.g., completely, partially, etc.) using an autonomous system 202 that is the same as or similar to autonomous system 202, described in reference to FIG. 2. In some embodiments, one or more of the steps of process 1000 are performed (e.g., completely, partially, and/or the like) by another device or system, or another group of devices and/or systems that are separate from, or include, the autonomous system. For example, one or more steps of process 1000 can be performed (e.g., completely, partially, and/or the like) by remote AV system 114, vehicle 102, and/or AV compute 400 (e.g., one or more systems of AV compute 400). In some embodiments, the steps of process 1000 may be performed between any of the above-noted systems in cooperation with one another.

At block 1002, a heating command is generated. The heating command includes an instruction to power on the IR emitter for a predetermined length of time. In examples, the predetermined length of time is proportional to the temperature measured at or near the component. In some embodiments, the heating command includes an intensity level of the radiation generated by the IR emitter. For example, if the temperature is below −5° C., the IR emitter is turned on for t seconds. The intensity of the IR emitter is adjusted based on a temperature gradient. For example, an IR emitter of an assembly corresponding to the first portion of the surface outputs energy at a higher intensity when compared to the intensity of energy output by an IR emitter of an assembly corresponding to the second, warmer portion of the surface.

At block 1004, the heating command is transmitted to a heating system (e.g., heating system 508 of FIG. 5). At block 1006, the heating command is executed at the heating system. In examples, executing the heating command includes powering on an IR emitter (e.g., IR emitter 510 of FIG. 5) for a length of time identified in the heating command. In some embodiments, the IR emitter is included in an IR assembly that includes one or more IR emitters, ring lens, ring wedge, or any combinations thereof. In examples, heating command includes a corresponding intensity for each IR emitter, where the intensity is proportional to an amount of heat generated by a respective IR emitter.

In examples, the process 1000 enables control of an assembly including one or more of an IR emitter, ring lens, ring wedge, or any combinations thereof. In some embodiments, the heating command includes an identification of a respective IR emitter or IR assembly and a predetermined temperature. The predetermined temperature is based on one or more temperatures, a temperature differential, known characteristics of the surface, or any combinations thereof.

According to some non-limiting embodiments or examples, provided is a system comprising an infrared emitter configured to output radiation; a ring lens that receives the radiation output by the infrared emitter and converges the radiation to a predetermined field coverage; and a surface of a component that receives the converged radiation within the predetermined field coverage and is heated, wherein the infrared emitter and ring lens are outside of a field of view of the component.

According to some non-limiting embodiments or examples, provided is a vehicle comprising: an infrared emitter configured to output radiation; a ring lens that receives the radiation output by the infrared emitter and converges the radiation to a predetermined field coverage; and a surface of a component that receives the converged radiation within the predetermined field coverage and is heated, wherein the infrared emitter and ring lens are outside of a field of view of the component.

According to some non-limiting embodiments or examples, provided is a method, comprising: determining, with at least one processor, a temperature at a component; generating, with the at least one processor, a heating command responsive to the temperature at the component, wherein the heating command comprises a duration and intensity of radiation; and executing, with the at least one processor, the heating command to heat a surface of the component by producing radiation by an IR emitter for the duration and intensity of radiation of the heating command, wherein the IR emitter is located outside of a field of view of the component.

Further non-limiting aspects or embodiments are set forth in the following numbered clauses:

Clause 1: A system, comprising: an infrared emitter configured to output radiation; a ring lens that receives the radiation output by the infrared emitter and converges the radiation to a predetermined field coverage; and a surface of a component that receives the converged radiation within the predetermined field coverage and is heated, wherein the infrared emitter and ring lens are outside of a field of view of the component.

Clause 2: The system of clause 1, comprising a ring wedge, wherein the ring wedge receives the converged radiation and redirects the converged radiation to a first portion of the surface.

Clause 3: The system of any one of clauses 1 or 2, wherein the radiation is a light beam output by the infrared emitter.

Clause 4: The system of any one of clauses 1-3, wherein the surface is heated by a plurality of IR assemblies, wherein an intensity of radiation of a respective IR assembly varies according to a temperature gradient of the surface.

Clause 5: The system of any one of clauses 1-4, wherein infrared emitter is a light emitting diode ring light.

Clause 6: The system of any one of clauses 1-5, wherein the component is a camera, and the surface to be heated is a lens or protective window, and lens barrel of the camera.

Clause 7: The system of any one of clauses 1-5, wherein the component is a LiDAR and the surface is a lens or protective window.

Clause 8: A vehicle, comprising: an infrared emitter configured to output radiation; a ring lens that receives the radiation output by the infrared emitter and converges the radiation to a predetermined field coverage; and a surface of a component that receives the converged radiation within the predetermined field coverage and is heated, wherein the infrared emitter and ring lens are outside of a field of view of the component.

Clause 9: The vehicle of clause 8, comprising a ring wedge, wherein the ring wedge receives the converged radiation and redirects the converged radiation to a first portion of the surface.

Clause 10: The vehicle of any one of clauses 8 or 9, wherein the radiation is a light beam output by the infrared emitter.

Clause 11: The vehicle of any one of clauses 8-10, wherein the surface is heated by a plurality of infrared (IR) assemblies, wherein an intensity of radiation of a respective IR assembly varies according to a temperature gradient of the surface.

Clause 12: The vehicle of any one of clauses 8-11, wherein the infrared emitter is a light emitting diode ring light.

Clause 13: The vehicle of any one of clauses 8-12, wherein the component is a camera, and the surface to be heated is a lens or protective window, and lens barrel of the camera.

Clause 14: The vehicle of any one of clauses 8-12, wherein the component is a LiDAR and the surface is a lens or protective window.

Clause 15: A method, comprising: determining, with at least one processor, a temperature at a component; generating, with the at least one processor, a heating command responsive to the temperature at the component, wherein the heating command comprises a duration and intensity of radiation; and executing, with the at least one processor, the heating command to heat a surface of the component by producing radiation by an infrared (IR) emitter for the duration and intensity of radiation of the heating command, wherein the IR emitter is located outside of a field of view of the component.

Clause 16: The method of clause 15, wherein an IR assembly includes the IR emitter, a ring lens, and a ring wedge, wherein the ring wedge receives converged radiation from the ring lens and redirects the converged radiation to a first portion of the surface.

Clause 17: The method of any one of clauses 15 or 16, wherein the surface is heated by a plurality of IR assemblies, wherein an intensity of radiation of a respective IR assembly varies according to a temperature gradient of the surface.

Clause 18: The method of any one of clauses 15-17, wherein the component is a camera.

Clause 19: The method of any one of clauses 15-17, wherein the component is a LiDAR.

Clause 20: The method of any one of clauses 15-17, wherein the component is a radar.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A system, comprising:
an infrared emitter configured to output radiation;
a ring lens that receives the radiation output by the infrared emitter and converges the radiation to a predetermined field coverage; and
a surface of a component that receives the converged radiation within the predetermined field coverage and is heated, wherein the infrared emitter and ring lens are outside of a field of view of the component.

2. The system of claim 1, comprising a ring wedge, wherein the ring wedge receives the converged radiation and redirects the converged radiation to a first portion of the surface.

3. The system of claim 1, wherein the radiation is a light beam output by the infrared emitter.

4. The system of claim 1, wherein the surface is heated by a plurality of IR assemblies, wherein an intensity of radiation of a respective IR assembly varies according to a temperature gradient of the surface.

5. The system of claim 1, wherein infrared emitter is a light emitting diode ring light.

6. The system of claim 1, wherein the component is a camera, and the surface to be heated is a lens or protective window, and lens barrel of the camera.

7. The system of claim 1, wherein the component is a LiDAR and the surface is a lens or protective window.

8. A vehicle, comprising:
an infrared emitter configured to output radiation;
a ring lens that receives the radiation output by the infrared emitter and converges the radiation to a predetermined field coverage; and
a surface of a component that receives the converged radiation within the predetermined field coverage and is heated, wherein the infrared emitter and ring lens are outside of a field of view of the component.

9. The vehicle of claim 8, comprising a ring wedge, wherein the ring wedge receives the converged radiation and redirects the converged radiation to a first portion of the surface.

10. The vehicle of claim 8, wherein the radiation is a light beam output by the infrared emitter.

11. The vehicle of claim 8, wherein the surface is heated by a plurality of infrared (IR) assemblies, wherein an intensity of radiation of a respective IR assembly varies according to a temperature gradient of the surface.

12. The vehicle of claim 8, wherein the infrared emitter is a light emitting diode ring light.

13. The vehicle of claim 8, wherein the component is a camera, and the surface to be heated is a lens or protective window, and lens barrel of the camera.

14. The vehicle of claim 8, wherein the component is a LiDAR and the surface is a lens or protective window.

15. A method, comprising:
determining, with at least one processor, a temperature at a component;
generating, with the at least one processor, a heating command responsive to the temperature at the component, wherein the heating command comprises a duration and intensity of radiation; and
executing, with the at least one processor, the heating command to heat a surface of the component by producing radiation by an infrared (IR) emitter for the duration and intensity of radiation of the heating command, wherein the IR emitter is located outside of a field of view of the component.

16. The method of claim 15, wherein an IR assembly includes the IR emitter, a ring lens, and a ring wedge, wherein the ring wedge receives converged radiation from the ring lens and redirects the converged radiation to a first portion of the surface.

17. The method of claim 15, wherein the surface is heated by a plurality of IR assemblies, wherein an intensity of radiation of a respective IR assembly varies according to a temperature gradient of the surface.

18. The method of claim 15, wherein the component is a camera.

19. The method of claim 15, wherein the component is a LiDAR.

20. The method of claim 15, wherein the component is a radar.
